(19) United States
(12) Patent Application Publication
(10) Pub. No.: US 2008/0045587 A1
(43) Pub. Date: Feb. 21, 2008

(54) PLANT PROTECTION

(76) Inventor: Jorg Peter SCHUR, Wegberg-Dalheim (DE)

Correspondence Address: PAUL AND PAUL, 2000 MARKET STREET, SUITE 2900, PHILADELPHIA, PA, 19103, US

(21) Appl. No.: 11/780,408

(22) Filed: Jul. 19, 2007

Related U.S. Application Data
(63) Continuation of application No. 10/069,476, filed on Jul. 1, 2002, now abandoned.

(30) Foreign Application Priority Data
Aug. 25, 1999 (DE) 199 40 283.3

(51) Int. Cl. A01N 43/16; A01N 31/00; A01P 1/00

(52) U.S. Cl. 514/460; 514/730

(57) ABSTRACT

The invention relates to methods for protecting plants and/or parts of plants from insects and insect larvae and from microbial attack. Said methods comprise the distribution or application of special insecticides or antimicrobial compositions on or to the surface of the plants and/or plant parts and/or the distribution of the compositions in the plant and/or the plant part. The invention also relates to insecticides and biocides containing these insecticides or antimicrobial compositions and to the use of the insecticides or antimicrobial compositions for treating plants and/or plant parts.

### CROSS-REFERENCE TO RELATED APPLICATIONS

This application is a continuation under 35 U.S.C. § 120 of co-pending U.S. patent application Ser. No. 10/069,476, filed Jul. 1, 2002, which is a national phase filing of co-pending International Application No. PCT/EP00/08344, filed Aug. 25, 2000, which claims the benefit of that application under 35 U.S.C. § 120, and which also claims the benefit under 35 U.S.C. § 119 of German Application No. 199 40 283.3, filed Aug. 25, 1999.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to methods for protecting plants and/or plant parts from insects and insect larvae and from microbial attack, comprising the distribution or application of specific insecticidal or antimicrobial compositions to the surface of the plants and/or plant parts, and/or the distribution of the compositions within the plant and/or plant part; insecticides and biocides comprising said insecticidal or antimicrobial compositions; and the use of said insecticidal or antimicrobial compositions for the treatment of plants and/or plant parts.

During growth and especially after the harvest, plants are sensitive towards molds, bacteria, insects and insect larvae which adversely affect the quality of the plants or of the harvested plant materials or destroy them or make them useless. In addition, especially in plants used as food or feed products, there is a great problem in that molds and bacteria bring toxins onto the plants and harvested plant materials whose ingestion may be noxious to humans and animals. Insects and insect larvae can contaminate or destroy the plants especially following the harvest, namely during storage or in the course of processing. These problems are aggravated by the fact that the use of biocides and insecticides must be discontinued one week before the harvest on principle, so that an effective antimicrobial and insecticidal protection generally is no longer available at the time of harvesting.

(2) Description of Related Art, Including Information Disclosed Under 37 C.F.R. §§ 1.97 and 1.98

It is known that tea-tree oil and oregano extracts when applied to plants act as repellants, i.e., exhibit some insecticidal property. In addition, from JP-A-62126931, it is known that vegetables can be sprayed for sterilization with an aqueous solution containing a flavonoid, an alcohol, such as ethanol, propylene glycol or glycerol, an organic acid and/or a calcium salt. However, these agents did not provide sufficient protection for the plants and plant parts from microbial and insect attacks. Further, WO 96/29895 and WO 98/58540 describe processing aids and additives for foodstuffs in which specific antimicrobial compositions containing at least two GRAS (generally recognized as safe) flavoring agents as antimicrobial components are employed.

### BRIEF SUMMARY OF THE INVENTION

It has been the object of the present invention to provide a method for providing sufficient antimicrobial and/or Insecticidal protection for plants, especially shortly before or after the harvest. Surprisingly, it has now been found that the compositions known from WO 96/29895 and WO 98/58540 have suitable antimicrobial properties which make them appear suitable for the present purpose. Especially, it was found that these compositions do not only act as repellants, but also hinder the growth or proliferation of insects and insect larvae in vivo. Finally, it was found among these compositions that particularly high antimicrobial and insecticidal activities are observed in those containing an aromatic GRAS flavor alcohol, especially the compositions containing benzyl alcohol, and those containing both a lipophilic and a hydrophilic GRAS flavoring agent. Due to their being toxicologically safe, such compositions may also be used shortly before or after the harvest.

Thus, the present application relates to:

(1) a method for protecting plants and/or plant parts from microbial attack, comprising the distribution or application of an antimicrobial composition to the surface of the plants and/or plant parts, said antimicrobial composition containing

(i) at least one lipophilic GRAS (generally recognized as safe) flavoring agent; and
(ii) at least one hydrophilic GRAS flavoring agent;
   (2) a preferred embodiment of the method as defined in (1) wherein said antimicrobial composition exclusively consists of GRAS flavoring agents;
   (3) a method for protecting plants and/or plant parts from microbial attack, comprising the distribution of said antimicrobial composition within the plant and/or plant part, said antimicrobial composition within the plant and/or plant part, said antimicrobial composition containing at least two GRAS (generally recognized as safe) flavoring agents;
   (4) a preferred embodiment of the method as defined in (3) wherein said antimicrobial composition contains
(A) one or more GRAS flavor alcohols (a) or their derivatives; and
(B) one or more flavoring agents selected from
   (b) polyphenol compounds; and
   (c) GRAS flavor acids or their derivatives;
      (5) a preferred embodiment of the methods as defined in (3) and (4) wherein said antimicrobial composition contains
(a1) benzyl alcohol as a necessary component; and optionally
(a2) one or more further GRAS flavor alcohols or their derivatives; and
(b) one or more polyphenol compounds; and/or
(c) one or more GRAS acids or their derivatives;
   (6) a preferred embodiment of the method as defined in (3) to (5) wherein said antimicrobial composition is as defined in (1) and (2);
   (7) a method for protecting plants and/or plant parts from insects and insect larvae, comprising:
(i) the distribution or application of an insecticidal composition to the surface of the plants and/or plant parts; and/or
(ii) the distribution of an insecticidal composition within the plant and/or plant part;
wherein said insecticidal composition is a composition containing GRAS flavoring agents as defined in (1) to (6);
   (8) an insecticide and/or repellant, comprising an insecticidal composition as defined in (1) to (5);
   (9) a biocide, especially fungicide and bactericide, comprising a composition as defined in (1) to (5), preferably as defined in (1) and (2);
   (10) the use of the composition as defined in (1) to (5), preferably as defined in (1) and (2), for treating plants and/or plant parts.

### BRIEF DESCRIPTION OF THE SEVERAL VIEWS OF THE DRAWING(S)

Not Applicable

### DETAILED DESCRIPTION OF THE INVENTION

The term “plants and/or plant parts” within the meaning of the present invention is to be understood as follows: During the nursing and growth to the harvest, the crops are referred to as viable organisms, i.e., “plants.” During the harvesting process, the plant is disrupted into individual parts, and these parts consisting of plant material are referred to as “plant parts” herein.

In the following, the substances which can be employed according to the invention, are further described in more detail.

The GRAS flavoring agents, GRAS flavor alcohols and GRAS flavor acids mentioned above in (1) to (5) are recognized by the FDA authority as commercially safe for use in foods (GRAS=generally recognized as safe in food). The mentioned GRAS flavoring agents are the compounds mentioned in the FEMA/FDA GRAS Flavor Substances Lists GRAS 3-15 Nos. 2001-3815 (as of 1997). This list contains natural and naturally occurring synthetic flavoring agents approved by the American public health authority, FDA, for use in foodstuffs: FDA Regulation 21 CFR 172.515 for naturally occurring synthetic flavoring agents (Synthetic Flavoring Substances and Adjuvants) and FDA Regulation 21 CFR 182.20 for natural favoring agents (Natural Flavoring Substances and Adjuvants). Suitable GRAS flavoring agents according to the present invention include, for example, (a) GRAS flavor alcohols or their derivatives, (b) polyphenol compounds, (c) GRAS flavor acids or their derivatives, (d) phenols or their derivatives, (e) esters, (f) terpenes, (g) acetals, (h) aldehydes and (i) essential oils.

In detail, the following GRAS flavor alcohols may be employed, for example: benzyl alcohol, acetoin (acetylmethylcarbinol), ethyl alcohol (ethanol), propyl alcohol (1-propanol), isopropyl alcohol (2-propanol, isopropanol), propylene glycol, glycerol, n-butyl alcohol (n-propyl carbinol), iso-butyl alcohol (2-methyl-1-propanol), hexyl alcohol (hexanol), L-menthol, octyl alcohol (n-octanol), cinnamyl alcohol (3-phenyl-2-propene-1-ol), α-methylbenzyl alcohol (1-phenyl-ethanol), heptyl alcohol (heptanol), n-amyl alcohol (1-pentanol), iso-amyl alcohol (3-methyl-1-butanol), anisalcohol (4-methoxybenzyl alcohol, p-anisalcohol), citronellol, n-decyl alcohol (n-decanol), geraniol, β,γ-hexenol (3-hexenol), lauryl alcohol (dodecanol), linalool, nerolidol, nonadienol (2,6-nonadiene-1-ol), nonyl alcohol (nonanol-1), rhodinol, terpineol, borneol, clineol (eucalyptol), anisole, cuminyl alcohol (cuminol), 10-undecene-1-ol, 1-hexadecanol. As said derivatives, both natural and synthetic (naturally occurring or not) derivatives can be employed. Suitable derivatives include, for example, the esters, ethers and carbonates of the above mentioned GRAS flavor alcohols. Particularly preferred GRAS flavor alcohols are benzyl alcohol, 1-propanol, glycerol, propylene glycol, n-butyl alcohol, citronellol, hexanol, linalool, acetoin and their derivatives.

As component (b), the following polyphenols may be employed: catechol, resorcinol, hydroquinone, phloroglucinol, pyrogallol, cyclohexane, resveratrol, usnic acid, acylpolyphenols, lignins, anthocyans, flavones, catechols, gallic acid derivatives (e.g., tannins, gallotannin, tannic acids, gallotannic acids), cranosol, carnosolic acid (including their derivatives, such as (2,5-dihydroxy-phenyl)carboxylic and (2,5-dihydroxyphenyl)alkylenecarboxylic substitutions, salts, esters, amides); caffeic acid and its esters and amides, flavonoids (e.g., flavone, flavonol, isoflavone, gossypetin, myricetin, robinetin, apigenin, morin, taxifolin, eriodictyol, naringen, rutin, hesperidin, troxerutin, chrysin, tangeritin, luteolin, catechols, quercetin, fisetin, kaempferol, galangin, rotenoids, aurones, flavonols, diols), extracts, e.g., from Camellia, Primula. Further, their possible derivatives, e.g., salts, acids, esters, oxides and ethers, may also be used. A particularly preferred polyphenol is tannin (a GRAS compound).

As component (c), the following GRAS acids may be used, for example: acetic acid, aconitic acid, adipic acid, formic acid, malic acid (1-hydroxysuccinic acid), capronic acid, hydrocinnamic acid (3-phenyl-1-propionic acid), pelargonic acid (nonanoic acid), lactic acid (2-hydroxypropionic acid), phenoxyacetic acid (glycolic acid phenyl ether), phenylacetic acid (α-toluenic acid), valeric acid (pentanoic acid), iso-valeric acid (3-methylbutyric acid), cinnamic acid (3-phenylpropenoic acid), citric acid, mandelic acid (hydroxyphenylacetic acid), tartaric acid (2,3-dihydroxybutanedioic acid; 2,3-dihydroxysuccinic acid), fumaric acid, tannic acid and their derivatives.

Suitable derivatives of the GRAS flavor acids according to the present invention are esters (e.g., C₁₋₆alkyl esters and benzyl esters), amides (including N-substituted amides) and salts (alkali, alkaline earth and ammonium salts) of the above mentioned acids. According to the present invention, the term “derivatives” also encompasses modifications of the side-chain hydroxy functions (e.g., acyl and alkyl derivatives) and modifications of the double bonds (e.g., the perhydrogenated and hydroxylated derivatives of the mentioned acids).

As component (d), the following phenol compounds may be employed: thymol, methyleugenol, acetyleugenol, safroi, eugenol, isoeugenol, anethole, phenol, methylchavicol (estragol; 3-(4-methoxyphenyl)-1-propene), carvacrol, α-bisabolol, formesol, anisole (methoxybenzene), propenylguaethol (5-propenyl-2-ethoxyphenol) and their derivatives. Derivatives within the meaning of the present invention are compounds in which the phenolic hydroxy group is esterified or etherified.

As GRAS esters (component (e)), for example, allicin and the following acetates may be used: iso-amyl acetate (3-methyl-1-butyl acetate), benzyl acetate, benzylphenyl acetate, n-butyl acetate, cinnamyl acetate (3-phenylpropenyl acetate), citronellyl acetate, ethyl acetate (acetic ester), eugenol acetate (acetyleugenol), geranyl acetate, hexyl acetate (hexanyl ethanoate), hydrocinnamyl acetate (3-phenylpropyl acetate), linalyl acetate, octyl acetate, phenylethyl acetate, terpinyl acetate, triacetin (glyceryl triacetate), potassium acetate, sodium acetate and calcium acetate. Further suitable esters are the ester derivatives of the above defined acids (component (b2)).

As terpenes (component (f)), there may be used, for example, camphor, limonene and β-caryophyllene.

The acetals (component (g)) which can be used include, e.g., acetal, acetaldehyde dibutyl acetal, acetaldehyde dipropyl acetal, acetaldehyde phenethyl propyl acetal, cinnamic aldehyde ethylene glycol acetal, decanal dimethyl acetal, heptanal dimethyl acetal, heptanal glyceryl acetal and benzaldehyde propylene glycol acetal.

As aldehydes (component (h)), there may be used, e.g., acetaldehyde, anisaldehyde, benzaldehyde, iso-butyl aldehyde (methyl-1-propanal), citral, citronellal, n-caprylic aldehyde (n-decanal), ethylvanillin, furfural, heliotropin (piperonal), heptyl aldehyde (heptanal), hexyl aldehyde (hexanal), 2-hexenal (β-propyl-acrolein), hydrocinnamic aldehyde (3-phenyl-1-propanal), lauryl aldehyde (do-decanal), nonyl aldehyde (n-nonanal), octyl aldehyde (n-octanal), phenylacetaldehyde (1-oxo-2-phenylethane), propionaldehyde (propanal), vanillin, cinnamic aldehyde (3-phenylpropenal), perillaldehyde and cuminaldehyde.

The following essential oils and/or alcoholic or glycolic extracts or extracts obtained by CO₂ high-pressure processes from the mentioned plants (component (i)) can also be employed according to the invention:

(i1) oils or extracts having a high content of alcohols: melissa, coriander, cardamon, eucalyptus;

(i2) oils or extracts having a high content of aldehydes: Eucalyptus citriodora, cinnamon, lemon, lemon grass, melissa, citronella, lime, orange;

(i3) oils or extracts having a high content of phenols: origanum, thyme, rosemary, orange, clove, fennel, camphor, mandarin, anise, cascarilla, estragon and pimento;

(i4) oils or extracts having a high content of acetates: lavender;

(i5) oils or extracts having a high content of esters: mustard, onion, garlic;

(i6) oils or extracts having a high content of terpenes: pepper, bitter orange, caraway, dill, lemon, peppermint, nutmeg.

In the following, the antimicrobial composition used in the above defined method (1) is further illustrated. In this composition, the lipophilic GRAS flavoring agents are preferably selected from (a₁) lipophillic GRAS flavor alcohols or their derivatives, (b) polyphenol compounds, (c₁) lipophilic GRAS flavor acids or their derivatives, (d) phenols or their derivatives, (e₁) lipophilic esters, (f) terpenes, (g) acetals, (h₁) lipophilic aldehydes and (i) essential oils. The antimicrobial composition preferably contains two of the mentioned GRAS flavoring agents.

Suitable lipophilic GRAS flavor alcohols (a₁) among the defined alcohols (a) include, in particular:

aromatic GRAS flavor alcohols, including benzyl alcohol, 2-phenylethanol, 1-phenylethanol, cinnamyl alcohol, hydrocinnamyl alcohol, 1-phenyl-1-propanol and anisalcohol, and aliphatic GRAS flavor alcohols, including n-butyl alcohol, iso-butyl alcohol, hexyl alcohol, L-menthol, octyl alcohol, heptyl alcohol, n-amyl alcohol, iso-amyl alcohol, anisalcohol, citronellol, n-decyl alcohol, geraniol, β,γ-hexenol, lauryl alcohol, linalool, nerolidol, nonadienol, nonyl alcohol, rhodinol, terpineol, borneol, clineol, anisole, cuminyl alcohol, 10-undecene-1-ol and 1-hexadecanol and their derivatives. The aromatic GRAS flavor alcohols, especially benzyl alcohol, are preferred.

According to the present invention, the hydrophilic GRAS flavoring agent is a hydrophillic alcoholic GRAS flavoring agent (aₕ) or a hydrophilic non-alcoholic GRAS flavoring agent, wherein said hydrophilic alcoholic GRAS flavoring agent (aₕ) is preferably a monohydric or polyhydric alcohol having from 2 to 10, more preferably from 2 to 7, carbon atoms, especially one selected from acetoin, ethyl alcohol, propyl alcohol, isopropyl alcohol, propylene glycol and glycerol, and said hydrophilic non-alcoholic GRAS flavoring agent is a hydrophilic organic GRAS flavor acid (cₕ) having from 1 to 15 carbon atoms or a physiological salt thereof, a hydrophilic acetate (eₕ) or a hydrophilic aldehyde (hₕ). Preferred hydrophilic organic acids (cₕ) include those which contain from 2 to 10 carbon atoms, especially acetic acid, aconitic acid, formic acid, malic acid, lactic acid, phenylacetic acid, citric acid, mandelic acid, tartaric acid, fumaric acid, tannic acid, hydrocinnamic acid and their physiological salts. Said hydrophilic acetate (eₕ) is preferably allicin, triacetin, potassium acetate, sodium acetate and calcium acetate. Said hydrophilic aldehyde (hₕ) is preferably selected from furfural, propionaldehyde and vanillin.

The lipophilic polyol compound (b), phenols or their derivatives (d), terpenes (f), acetals (g) and essential oils (i) in the composition of method (1) are preferably the above defined compounds (b), (d), (f), (g) and (i). The lipophilic GRAS flavor acids or their derivatives (cₗ), lipophilic esters (eₗ) and lipophilic aldehydes include all specifically mentioned acids, esters and aldehydes, except for the compounds (cₕ), (eₕ) and (hₕ) specifically mentioned above.

In a preferred embodiment of method (1), the antimicrobial composition contains either:

(i) two lipophilic GRAS flavor alcohols (aₗ), but no benzyl alcohol and no polyphenol compounds (b); or

(ii) benzyl alcohol and/or a polyphenol compound (b), but no further GRAS flavor alcohols.

It is particularly preferred for the antimicrobial composition to contain exclusively non-alcoholic hydrophilic GRAS flavoring agents, especially exclusively a hydrophilic GRAS flavor acid (Cₕ), and for the antimicrobial composition to contain from 0.01 to 99% by weight, preferably from 0.1 to 90% by weight, of benzyl alcohol or polyphenol compounds (b) and from 0.01 to 50% by weight, preferably from 0.1 to 30% by weight, of hydrophilic non-alcoholic GRAS flavoring agents.

In a further preferred embodiment of method (1), the antimicrobial composition contains:

(A) one or more GRAS flavor alcohols (a) or their derivatives; and

(B) one or more flavoring agents selected from polyphenol compounds (b) and lipophilic GRAS flavor acids or their derivatives (c).

It is preferred for the composition to contain from 0.1 to 99% by weight, preferably from 0.5 to 99% by weight, of component (a), from 0 to 25% by weight, preferably from 0.01 to 10% by weight, of component (b), and from 0 to 70% by weight, preferably from 0.01 to 30% by weight, of component (c).

In addition, the antimicrobial composition may contain further GRAS flavoring agents selected from (d) phenols or their derivatives, (eₗ) lipophilic esters, (f) terpenes, (g) acetals, (hₗ) lipophilic aldehydes and (i) essential oils.

It is further preferred for component (A) of the antimicrobial composition to contain benzyl alcohol as a necessary component (a1) and optionally one or more further lipophilic GRAS flavor alcohols or their derivatives (aₗ). Preferably, this antimicrobial composition contains:

from 0.1 to 99% by weight, preferably from 0.1 to 75% by weight, of benzyl alcohol;

from 0 to 99.8% by weight, preferably from 0.01 to 99% by weight, of component (aₗ); and

from 0 to 25% by weight, preferably from 0.01 to 10% by weight, of component (b);

from 0 to 70% by weight, preferably from 0.01 to 30% by weight, of component (c).

The composition employed may contain further lipophilic GRAS flavoring agents (d) to (i) as defined above, preferably from 0.001 to 25% by weight, more preferably from 0.01 to 9% by weight, of said further GRAS flavoring agents (d) to (i). Said further lipophilic GRAS flavoring agents more preferably include phenols (d) and/or essential oils (i).

In a further particularly preferred embodiment of method (1), component (A) of the antimicrobial composition consists of two lipophilic GRAS flavor alcohols, and component (B) contains at least one polyphenol compound (b). Said polyphenol compound (b) is preferably tannin, particularly preferred being a composition which contains from 20 to 98% by weight of benzyl alcohol and from 0.01 to 10% by weight of tannin.

In the following, preferred embodiments of the antimicrobial/insecticidal composition employed in methods (3) and (7) are illustrated in more detail: Preferably, the antimicrobial/insecticidal composition contains at least one GRAS flavor alcohol (a), especially benzyl alcohol. Preferred are those compositions which contain less than 50% by weight, preferably less than 30% by weight, more preferably less than 20% by weight, of ethanol, isopropanol or benzyl alcohol or a mixture of these substances.

In another preferred embodiment of methods (3) and (7), the antimicrobial/insecticidal composition contains at least one hydrophilic alcoholic GRAS flavoring agent and/or one hydrophilic non-alcoholic GRAS flavoring agent. The proportion of hydrophilic alcoholic GRAS flavoring agents may be up to 99% by weight of the insecticidal composition and is preferably from 30 to 98% by weight, more preferably from 80 to 95% by weight. The proportion of hydrophilic non-alcoholic GRAS flavoring agents in the insecticidal composition may be up to 90% by weight and is preferably from 0.1 to 50% by weight. Preferred are those compositions which further contain benzyl alcohol and/or a polyphenol compound (b) in addition to the mentioned hydrophilic compounds.

Hydrophilic alcoholic GRAS flavoring agents are the above defined compounds (aₕ). Hydrophilic non-alcoholic GRAS flavoring agents include, in particular, the above defined organic acids (cₕ).

Further preferably employed antimicrobial/insecticidal compositions are the compositions stated above under (4) and (5). The composition as defined under (4) may contain:

from 0.1 to 99.9% by weight, preferably from 0.5 to 99% by weight, of component (a);

from 0 to 25% by weight, preferably from 0.01 to 10% by weight, of component (b); and

from 0 to 70% by weight, preferably from 0.01 to 30% by weight, of component (c).

In this embodiment of the invention, component (a) contains one or more GRAS flavor alcohols. Preferred is the use of two or three GRAS flavor alcohols. The mixing ratio of component (a) to component (b) is preferably between 10,000:1 and 1:10,000, more preferably between 1000:1 and 1:1000, and still more preferably between 100:1 and 1:100.

In the method according to the invention as defined above under (4), the composition may contain further GRAS flavoring agents, such as the above defined GRAS flavor alcohols or their derivatives (a) with the exception of benzyl alcohol, polyphenol compounds (b), acids (c), phenols (d), esters (e), terpenes (f), acetals (g), aldehydes (h) and essential oils (i).

Preferred antimicrobial/insecticidal compositions according to the present invention are those which contain less than 50% by weight, preferably less than 30% by weight, more preferably less than 20% by weight, of benzyl alcohol or of a mixture of benzyl alcohol with ethanol and/or isopropanol.

In a further preferred embodiment of the present invention, the antimicrobial/insecticidal composition contains at least one hydrophilic alcoholic GRAS flavoring agent and/or one hydrophilic non-alcoholic GRAS flavoring agent. As to the proportion of the hydrophilic compound and as to particularly preferred hydrophilic compounds, reference is made to the above indications. Particularly preferred in this connection are those antimicrobial/insecticidal compositions which contain polyphenol compounds in addition to benzyl alcohol and the mentioned hydrophilic GRAS flavoring agents.

As mentioned above under (5), in a particularly preferred embodiment of the method according to the invention, the insecticidal or antimicrobial composition contains:

(a1) benzyl alcohol as a necessary component; and optionally

(a2) one or more further GRAS flavor alcohols or their derivatives; and

(b) one or more polyphenol compounds; and/or

(c) one or more GRAS acids or their derivatives.

Suitable amounts of components (a1), (a2), (b) and (c) in the above defined insecticidal and antimicrobial composition are:

from 0.1 to 99% by weight, preferably from 0.1 to 75% by weight, of benzyl alcohol;

from 0 to 99.8% by weight, preferably from 0.01 to 99% by weight, of component (a2);

from 0 to 25% by weight, preferably from 0.01 to 10% by weight, of component (b1); and/or

from 0 to 70% by weight, preferably from 0.01 to 30% by weight, of component (b2).

The particularly preferred insecticidal and antimicrobial composition may further contain the above mentioned components (d) to (i), which are also GRAS flavoring agents.

The proportion of components (d) to (i) in the antimicrobial composition is preferably equal to or smaller than 25% by weight, preferably within a range of from 0.001 to 9% by weight. Preferred among the further GRAS flavoring agents are the phenols (d) and the essential oils (i).

Most preferred for methods (3) and (7) of the present invention are those antimicrobial or insecticidal compositions which correspond to the compositions defined above under (1) and (2), i.e., compositions containing at least one hydrophilic GRAS flavoring agent, wherein the component thereof having insecticidal or antimicrobial activity optionally consists exclusively of GRAS flavoring agents, i.e., does not contain any derivatives of the GRAS flavoring agents. As an example of such a composition, there may be mentioned a mixture of benzyl alcohol, one or two of the above mentioned GRAS flavor alcohols (a2) and tannic acid. Such mixture preferably contains form 20 to 98% by weight of benzyl alcohol and from 0.01 to 10% by weight of tannic acid. Another example of a preferred composition is a mixture of 2 alcohols, a polyphenol (especially tannic acid) and an essential oil (especially a phenolic essential oil, component (h3)).

In addition to components (a) to (i), the antimicrobial/insecticidal compositions may additionally contain further compounds (j), such as alcohols (j1), emulsifiers (j2), stabilizers (j3), antioxidants (j4), preservatives (j5), solvents (j6), carriers (j7) etc.

The solvents (j6) include, for example, vegetable materials including rapeseed oil, soybean oil, edible fatty acids etc., and chemical solvents including nitroturpentines, polyurethanes, aliphatic hydrocarbons, isoparaffin etc., and mixtures thereof.

The proportion of components (j) in the insecticidal or antimicrobial composition may be up to 95% by weight, is preferably lower than 10% by weight and is preferably within a range of from 0.1 to 5% by weight.

According to the invention, the alcohols (j1) are monohydric or polyhydric alcohols having from 2 to 10 carbon atoms, preferably from 2 to 7 carbon atoms, not including the GRAS alcohols (a). Preferably, such amounts of GRAS flavor alcohols (a) and further alcohols (j1) are employed that their mixing ratio is between 1000:1 and 1:1000, especially between 100:1 and 1:100, more preferably between 10:1 and 1:10.

It is particularly preferred in the method according to the present invention to use systems which exclusively consist of GRAS flavoring agents, especially when the treated plants and/or plant parts are later ingested as foods, beverages or luxuries or otherwise come into contact with the human body, because this prevents contamination of the plants and/or plant parts with non-GRAS compounds. Further, it should be taken care that the insecticidal and antimicrobial composition is free of ethanol and isopropanol, or free of noxious doses of ethanol and isopropanol, since these substances can be absorbed by the plants and/or plant parts, and can be inhaled by the persons who further process such plants. In addition, there may be a danger of explosion when these compounds are used.

The method according to the invention is suitable for the treatment of plants during nursing and growth, especially shortly before the harvest (e.g., during the last week before the harvest) and also after the harvesting of the plants. The insecticidal and/or antimicrobial treatment may be both by application to the surface of the plants and/or plant parts (e.g., by spraying, immersion, nebulizing, etc.) and during growth of the plants by adding the insecticidal or antimicrobial composition to nutrient media, nutrient liquids, water etc. In the latter way, the insecticidal or antimicrobial composition is distributed within the plant or plant part. The insecticidal and/or antimicrobial composition can be contacted with the plants both in undiluted form and diluted in aqueous solvent systems, organic solvent systems and/or oil suspensions.

It could be shown that concentrations of the insecticidal and/or antimicrobial composition within a range of from 0.001 to 100 mg/g of plant, preferably from 0.1 to 10 mg/g of plant, ensure sufficient insecticidal land antimicrobial protection when the composition is applied to plant surfaces. When applied in nutrient media and nutrient solutions, a concentration of the antimicrobial composition of from 0.001 to 100, preferably from 0.1 to 10 mg, per g of nutrient medium or nutrient solution is sufficient. For economical reasons, it is a matter of course that as low as possible a concentration of the insecticidal or antimicrobial composition will be employed.

In particular, the method according to the invention is suitable for the treatment of, for example, cotton, cereals, rice, corn, potatoes, tobacco, coffee, tea, vegetables, fruits, seeds of the mentioned plants, nuts, spices, herbs, ornamental plants, cultured flowers and flowers for cutting, and for plant cultivation.

Especially, the method according to the invention significantly reduces or even completely suppresses the microorganisms, agents of decay, mycotoxin formers and parasites stated in the following list.

| Molds | Culture/plant (illustrative) |
|---|---|
| mildew species | cereals (field fungi) |
| rust fungi | cereals (field fungi) |
| leaf spot fungi | cereals (field fungi) |
| Fusarium species | cereals (field/storage fungi) |
| Aspergillus species | cereals (storage fungi) |
| Penicillium species | cereals (storage fungi) |
| Rhizoctonia | tobacco, rape |
| Peronaspora | tobacco |
| Phytophtora | tobacco |
| Botrytis cinerea | tobacco |
| Rhizoctonia solani | rice |
| Aspergillus ocraceus | coffee |
| Aspergillus niger | coffee |
| Clavosporium fusarium | coffee |
| Penicilliums | coffee |

| | | Culture/plant |
|---|---|---|
| Parasites | | (illustrative) |
| Lepidoptera | | tomatoes; cotton |
| Lepidoptera | (Chilo suppressalis) | rice |
| | (Chaphalocrosis medinalis) | rice |
| | (Ostrina nubilalis) | corn |

| | | |
|---|---|---|
| Myzus persicase | (Chaphalocrosis medinalis) | tobacco |

| Viruses | Culture/plant (illustrative) |
|---|---|
| tomato mosaic virus | tomatoes |
| X virus | potatoes |
| Y virus | potatoes |
| rice stripe virus | rice |
| TYM virus | rape |
| Rhizomania | sugar beet |
| BNYVV | sugar beet |

In addition to the insecticidal or antimicrobial composition, the insecticides and biocides (i.e., bactericides, fungicides, virucides, sporicides) according to the invention may contain further compounds, such as the above mentioned compounds (i1) to (i7). In addition, the insecticides and biocides according to the invention may also be in the form of retard preparations. Such retard preparations are preferred, in particular, for use in nutrient media in order to thereby ensure as long as possible an insecticidal or biocidal activity. Suitable retard preparations include, for example, microcapsules or coatings in which the active substance is encapsulated or coated with a suitable encapsulating or coating material, such as cellulose derivatives.

The present invention is further illustrated by means of the following Examples. Further useful insecticidal and antimicrobial compositions in addition to the composition of the following Example are mentioned in WO 96/29859 and WO 98/58540, which are included herein by reference.

### EXAMPLES

The following culture plants are sprayed with an insecticidal/antimicrobial composition which contains the following components (in % by weight):

10.0% polyphenol (here: tannin)

18.2% benzyl alcohol

60.0% propylene glycol

8.0% lactic acid

3.8% essential oil (here: a phenol-containing essential oil)

The results are summarized in the following Tables 1 to 3.

TABLE 1
Wheat.

| | | | Molds Section 35 | |
|---|---|---|---|---|
| | | | LMBG (German | |
| | | | Food and | |
| | | | Consumer | |
| | 50% | | Goods Act) | Parasite larvae |
| | solution in | Spraying agent | (S.A.) | (S.A.) |
| W-0 | | blank, untreated | 5 × 10⁴/g | populated |
| | | | | 6 months |
| | | | | after harvest |
| W-1 | water | 0.001 mg/g | 7 × 10³/g | no growth |
| W-2 | water | 0.01 mg/g | 1 × 10³/g | no growth |
| W-3 | water | 0.1 mg/g | 6 × 10²/g | no growth |
| W-4 | water | 1 mg/g | 7 × 10¹/g | no growth |
| W-5 | water | 10 mg/g | 2 × 10¹/g | no growth |
| W-6 | water | 100 mg/g | <10/g | no growth |
| W-7 | solvent* | 0.001 mg/g | 5 × 10³/g | no growth |
| W-8 | solvent* | 0.01 mg/g | 4 × 10³/g | no growth |
| W-9 | solvent* | 0.1 mg/g | 3 × 10²/g | no growth |
| W-10 | solvent* | 1 mg/g | 6 × 10¹/g | no growth |
| W-11 | solvent* | 10 mg/g | 3 × 10¹/g | no growth |
| W-12 | solvent* | 100 mg/g | 1 × 10¹/g | no growth |

*here: rapeseed oil

TABLE 2
Tobacco.

| | | | Molds Section | |
|---|---|---|---|---|
| | | | 35 LMBG | |
| | | | (German Food | |
| | | | and Consumer | |
| | 50% | | Goods Act) | Parasite larvae |
| | solution in | Spraying agent | (S.A.) | (S.A.) |
| T-0 | | blank, untreated | 6 × 10⁴/g | populated |
| | | | | 6 months |
| | | | | after harvest |
| T-1 | water | 0.001 mg/g | 5 × 10⁴/g | no growth |
| T-2 | water | 0.01 mg/g | 1 × 10⁴/g | no growth |
| T-3 | water | 0.1 mg/g | 8 × 10³/g | no growth |
| T-4 | water | 1 mg/g | 4 × 10²/g | no growth |
| T-5 | water | 10 mg/g | 6 × 10¹/g | no growth |
| T-6 | water | 100 mg/g | <10/g | no growth |
| T-7 | solvent* | 0.001 mg/g | 6 × 10⁴/g | no growth |
| T-8 | solvent* | 0.01 mg/g | 8 × 10³/g | no growth |
| T-9 | solvent* | 0.1 mg/g | 2 × 10³/g | no growth |
| T-10 | solvent* | 1 mg/g | 4 × 10²g | no growth |
| T-11 | solvent* | 10 mg/g | 6 × 10¹/g | no growth |
| T-12 | solvent* | 100 mg/g | 4 × 10¹/g | no growth |

*here: rapeseed oil

TABLE 3
Raw Coffee.

| | | | Molds Section | |
|---|---|---|---|---|
| | | | 35 LMBG | |
| | | | (German Food | |
| | | | and Consumer | |
| | 50% | | Goods Act) | |
| | solution in | Spraying agent | (S.A.) | Parasite larvae |
| C-0 | | blank, untreated | 4 × 10⁴/g | populated |
| | | | | 6 months |
| | | | | after harvest |
| C-1 | water | 0.001 mg/g | 9 × 10³/g | no growth |
| C-2 | water | 0.01 mg/g | 4 × 10³/g | no growth |
| C-3 | water | 0.1 mg/g | 7 × 10³/g | no growth |
| C-4 | water | 1 mg/g | 1 × 10³/g | no growth |
| C-5 | water | 10 mg/g | 3 × 10²/g | no growth |
| C-6 | water | 100 mg/g | 8 × 10¹/g | no growth |
| C-7 | solvent* | 0.001 mg/g | 2 × 10⁴/g | no growth |
| C-8 | solvent* | 0.01 mg/g | 3 × 10³/g | no growth |
| C-9 | solvent* | 0.1 mg/g | 8 × 10²/g | no growth |
| C-10 | solvent* | 1 mg/g | 4 × 10²/g | no growth |
| C-11 | solvent* | 10 mg/g | 6 × 10¹/g | no growth |
| C-12 | solvent* | 100 mg/g | <10/g | no growth |

*here: rapeseed oil

1. A method for protecting wheat prior to harvest from microbial attack, comprising the step of applying an antimicrobial composition to the surface of the wheat, wherein said antimicrobial composition consists essentially of:
(i) benzyl alcohol and
(ii) propylene glycol.

2. A method for protecting wheat prior to harvest from microbial attack, comprising the step of applying an antimicrobial composition to the surface of the wheat, wherein said composition consists essentially of propylene glycol and tannic acid.

3. The method according to claim 2, wherein said antimicrobial composition comprises from 0.01 to 50% by weight of tannic acid.

4. A method for protecting wheat prior to harvest from microbial attack, comprising the step of applying an antimicrobial composition to the surface of the wheat, wherein said antimicrobial composition consists essentially of propylene glycol, tannic acid and benzyl alcohol.

5. The method according to claim 4, wherein said antimicrobial composition comprises from 0.01 to 99% by weight of benzyl alcohol and from 0.01 to 50% by weight of tannic acid.

6. The method according to claim 4, wherein said antimicrobial composition comprises:
from 0.1 to 99% by weight of benzyl alcohol,
and form 0.01 to 50% by weight of tannic acid.

7. The method according to claim 4, wherein said antimicrobial composition consists essentially of from 20 to 98% by weight of benzyl alcohol and from 0.01 to 10% by weight of tannic acid.

8. The method according to claim 1, wherein said step of applying said antimicrobial composition to the surface of the wheat is carried out by spraying.

9. The method according to claim 2, wherein said step of applying said antimicrobial composition to the surface of the wheat is carried out by spraying.

10. The method according to claim 4, wherein said step of applying said antimicrobial composition to the surface of the wheat is carried out by spraying.
